(19) United States
(12) Patent Application Publication
(10) Pub. No.: US 2012/0203700 A1
(43) Pub. Date: Aug. 9, 2012

(54) TOKENIZED CONTACTLESS PAYMENTS FOR MOBILE DEVICES

(75) Inventors: Matthew R. Ornce, Wilmington, DE (US); Raymond Moyer, Landenberg, PA (US); Gregory J. Sackenheim, West Chester, OH (US); Alec B. Dollarhide, Scottsdale, AZ (US); Kent R. Glenn, Buckeye, AZ (US); Steven H. Pile, Cave Creek, AZ (US)

(73) Assignee: ELECTRONIC PAYMENT EXCHANGE, Wilmington, DE (US)

(21) Appl. No.: 13/315,544

(22) Filed: Dec. 9, 2011

Related U.S. Application Data
(60) Provisional application No. 61/421,814, filed on Dec. 10, 2010.

(51) Int. Cl. G06Q 20/40

(52) U.S. Cl. 705/67

(57) ABSTRACT

According to an exemplary embodiment of the invention, a method is discloses for facilitating a credit card transaction wirelessly via a mobile device. The method includes receiving registration information for a credit card and a mobile device, the registration information for the credit card including a primary account number (PAN) of the credit card; associating the registration information for the credit card with a unique token; generating a pseudo-PAN based on the PAN, the pseudo-PAN being different than the PAN; and providing the unique token and the pseudo-PAN to the mobile device for use in one or more credit card transactions.

### CROSS REFERENCE TO RELATED APPLICATIONS

This application claims the benefit of U.S. Provisional Patent Application Ser. No. 61/421,814, filed on Dec. 10, 2010, the contents of which are hereby incorporated by reference in their entirety.

### TECHNICAL FIELD

This application is related to processing consumer credit card payments.

### BACKGROUND

In order to receive goods or services from a merchant, consumers may need to have their credit card authorized. This process typically involves giving the consumer's credit card information to the merchant, who enters it into their systems to send to their processor. The processor in turn sends it to the card network, which finally sends the consumer's credit card information to the financial institution that issued the credit card. The card issuer determines if the transaction is approved or not, and sends their decision back through the payment chain to the merchant in real-time.

For the merchants to receive payment for an approved transaction, they must typically submit a follow-up transaction to the authorization request. This second transaction is a request to move the funds from the consumer's account at the card issuer to the merchant's account. This process may also involve sending the consumer's credit card information from the merchant to the processor, card network and finally, the card issuer.

Traditional retail transactions in the United States convey data from the credit card's magnetic stripe (“track data”) as encoded by the card issuers by making physical contact with the credit card's magnetic stripe. Among other information, track data contains the consumer's credit card number. The track data on the magnetic stripe is often intended to be immutable—it may not change over the life of the card. Any changes to the track data may be detected as a fraudulent transaction.

A recent trend in retail payments is the use of contactless payments. This has been accomplished in one of two ways: chips embedded in otherwise traditional credit cards that allow for wireless communication, or stickers that can be applied to any surface, with a similarly embedded chip. In both cases, the traditional card issuer controls the supply of the technology to the consumer and any cost they choose to pass on. Both technologies transfer from the card or sticker a string of data that mimics the track data to the merchant's contactless terminal receiver.

An example technology for implementing contactless payments is Near Field Communication (NFC), which is based on a short-range wireless connectivity. NFC hardware is activated by bringing two compatible devices in very close proximity to one another, or by literally touching them together. NFC is compatible with the existing contactless reader infrastructure that is used daily by millions of people and devices worldwide.

### SUMMARY

Using an NFC-capable mobile device, a consumer can register their credit card(s) with a service that supplies a mobile device application that houses the payment information. Rather than storing the actual credit card number in the device, however, a pseudo-credit card number is stored. A unique token can be embedded in the pseudo credit card information so that the actual credit card information can be identified from the token.

During a contactless retail transaction, this pseudo-credit card number may route the transaction through the existing, unmodified payment network infrastructure to the service provider. Based on the unique token embedded in payment information, the service provider would retrieve the consumer's actual credit card number and forward it back into the payment network in order to route authorization and settlement requests to the consumer's actual credit card issuer, whose response and/or funds would then be sent back to the merchant.

After each transaction, a new token may be generated and embedded in new payment information that would then be updated in the consumer's mobile device application, preventing any type of attack where in-flight transaction data is captured (and possibly altered), from being successfully replayed. This system could protect the consumer's credit card number from exposure from the following breaches: a breach of the consumer's mobile device, a breach of the communication between the mobile device and the merchant's contactless terminal receiver, a breach of the merchant's payment systems, or a breach of the merchant's payment processor.

By leveraging a consumer's NFC-capable mobile device and substituting their credit card number for a one-time or limited-use token, this system enables the consumer to proactively protect their own credit card number and make payments more securely. The actual card number is only shared between credit card issuers and networks—backend payment entities that specialize in handling payment data. The merchant—and even the consumer—no longer need to have access to the actual card number to conduct a contactless retail sale, meaning that it's no longer available in the places its most likely to be stolen and misused.

Using standard contactless payment equipment already in commercial use, this more secure payment is accomplished without requiring any merchant changes (no need for a new merchant processor, a different acquiring relationship, etc.) and only requiring a minor consumer behavior change. The system would allow merchant receipts to display the card brand and/or last four digits of the card number without modification or invention on the merchant's part, despite the use of a pseudo-credit card number.

According to an exemplary embodiment of the invention, a method is discloses for facilitating a credit card transaction wirelessly via a mobile device. The method includes receiving registration information for a credit card and a mobile device, the registration information for the credit card including a primary account number (PAN) of the credit card; associating the registration information for the credit card with a unique token; generating a pseudo-PAN based on the PAN, the pseudo-PAN being different than the PAN; and providing the unique token and the pseudo-PAN to the mobile device for use in one or more credit card transactions.

According to another exemplary embodiment, a method is disclosed for facilitating a credit card transaction via a mobile device. The method includes receiving a unique token and a pseudo-PAN; identifying an actual PAN based on the unique token and the pseudo-PAN, the pseudo-PAN being associated with the actual PAN, the pseudo PAN being different than the actual PAN; and sending the actual PAN to an entity that uses the actual PAN to determine if the credit card transaction is approved.

### BRIEF DESCRIPTION OF THE DRAWINGS

FIG. 1 is system diagram of a system for authorizing a credit card transaction.

FIG. 2 is a system diagram of a system capable of settlement of a credit card transaction.

FIG. 3 is a system diagram for registering consumer credit information according to an embodiment.

FIG. 4A and FIG. 4B are system diagrams and descriptions for authorizing a credit card transaction according to an embodiment.

FIG. 5 is a system diagram for credit card settlement according to an embodiment.

FIG. 6 is a block diagram of one embodiment of a computer system in which aspects of the disclosed systems and methods may be embodied.

### DETAILED DESCRIPTION OF ILLUSTRATIVE EMBODIMENTS

The following numbering system and category relationships are used in the descriptions and diagrams: (1xx) Consumer, and related entities, (2xx)=Mobile Token Card Issuer, and related entities, (3xx)=Tokenization Service, and related entities, (4xx)=Consumer's Mobile Carrier, and related entities, (5xx)=Merchant, and related entities, (6xx)=Card Network, and related entities. Consumer 100 may be a person or entity attempting to purchase goods and/or services using a credit or debit card. Merchant 500 may be an entity attempting to sell goods and/or services to a Consumer 100. Merchant Processor 502 may connect Merchants 500 to the Card Networks 600 by taking the authorization data from the Merchants 500, authorizing sales with the issuing banks and settling funds through the Card Networks' 600 interchange system. For example, Consumer's Card Issuer 112 may be a Merchant Processor 502.

A mobile device may be any electronic device that is capable of transmitting or receiving wireless signals via one or more wireless interfaces. For example, a mobile device may be a cellular device, personal digital assistant (PDA), mobile phone, mobile internet device, portable media player, handheld game console, pager, personal navigation device, mobile computer, or the like.

Card Network 600 may be any one of the Visa, MasterCard or Discover, etc. card networks, which run payment networks that connect all of the Merchant Processors 502 with all of that brand's issuing banks, and may manage the collection and distribution of data and fees between them. A Bank Identification Number (BIN) is typically the first 6 digits of a credit card number that identifies both the credit card brand (i.e. Visa, MasterCard, Discover, American Express, etc.) as well as the specific card issuing institution (“issuer”). During authorization and settlement, the BIN may be used to automatically route the transaction through the card networks to the correct issuer for approval and movement of funds. Consumer's Card Issuer 112 may be the financial institutions that issue the credit or debit card to Consumers 100, manage their account balance and standing, and periodically distribute Credit Card Statements 114.

Tokenization Service 300 may provide a unique identifier (token) in exchange for the Consumer's Credit Card Information 102 in order to facilitate a transaction between the Consumer 100 and the Merchant 500 without directly using the Consumer's Credit Card Information 102 between these entities. The Tokenization Service 300 may also provide the Consumer's Credit Card Information 102 in exchange for a unique identifier (Token 304) in order to facilitate a transaction between the Mobile Token Card Issuer 200 and the Consumer's Card Issuer 112. The Tokenization Service 300 may also provide New Tokens 308 that relate to the Consumer's Credit Card Information 102 represented by the original Token 304.

Mobile Token Card Issuer 200 may be the initial recipient of transactions routed from the Card Network 600 based on the BIN. The Mobile Token Card Issuer 200 may re-route the authorization and settlement requests back into the Card Network 600 after retrieving the original card information based on the unique identifier (token) embedded in the track data of the Consumer's Credit Card Information 102. Mobile Token Card Issuer 200 may also send non-credit card consumer information to the Consumer's Mobile Carrier 400 to update the Payment App 402 on the Consumer's Mobile Device 106. Consumer's Mobile Carrier 400 may be a carrier that operates facilities for the purposes of providing public mobile telecommunications services. This is typically chosen by the Consumer 100 when they purchase the Consumer's Mobile Device 106.

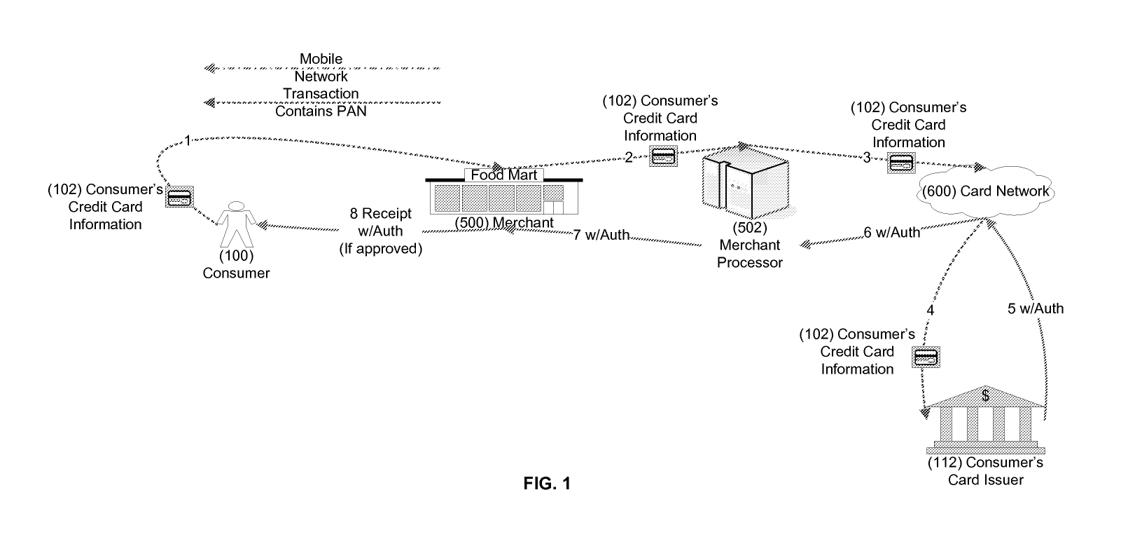

FIG. 1 is system diagram of a system for authorizing a credit card transaction without the use of tokenization service 300. To begin a financial transaction, a Consumer 100 purchases products or services from a Merchant 500 using the Consumer's Credit Card Information 102 (step 1). The Consumer's Credit Card Information 102 may be passed from the Merchant 500 to the Merchant Processor 502 (step 2), who routes it to the Card Network 600 corresponding to the card brand in the Personal account number (PAN) embedded in the Consumer's Credit Card Information 102 (step 3). The Card Network 600 routes the Consumer's Credit Card Information 102 to the specific card issuing institution that issued the Consumer's 100 card, the Consumer's Card Issuer 112, based on the BIN of the PAN of the Consumer's Credit Card Information 102 (step 4).

The Consumer's Card Issuer 112 approves or declines the authorization request, based on the parameters and thresholds established for the Consumer 100, and responds back to the Card Network 600 with the authorization response (step 5). The Card Network 600 responds back with the authorization response to the Merchant Processor 502 (step 6), who, in turn, forwards it to the Merchant 500 (step 7). If approved, the Consumer 100 receives the desired goods and/or services from Merchant 500, along with a sales receipt (step 8). This process, which is the payment industry standard, exposes the consumer's credit card information to the merchant, where the greatest number of data breaches occurs. This process may include several transmissions (i.e., steps 1-4) which contain some portion of the Consumer's Credit Card Information (102), including the PAN.

In order to receive payment, the merchant typically submits a follow-up transaction to the authorization request, after the consumer has already been authorized to receive goods and/or services. This second transaction, known as settlement, is a request to move the funds from the consumer's account at their card issuer to the merchant. Similar to the authorization request, the merchant payment system sends the settlement request, including the consumer's credit card information, to their processor, although this is typically performed as part of an end-of-day batch, rather than in real-time. The processor in turn sends it to the card network. The card network computes certain fees, and debits the funds from the issuer, and credits them, less fees, to the acquiring bank associated with the merchant's processor. The merchant's processor subtracts additional fees, and sends the balance to the merchant.

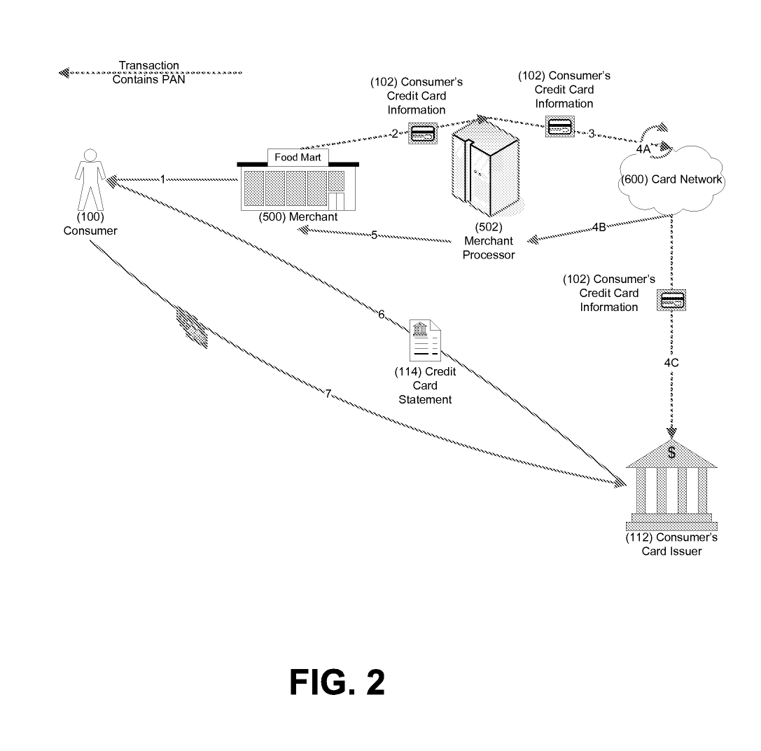

FIG. 2 is a system diagram of a system capable of settlement of a credit card transaction without the use of the tokenization service 300. After completion of authorization, Consumer 100 has been approved to receive goods and/or services from Merchant 500 (step 1). As part of a typically daily process, Merchant 500 transmits the Consumer's Credit Card Information 102 from the previously authorized transaction to the Merchant Processor 502 as a request for settlement funds (step 2). The Consumer's Credit Card Information 102 may then be passed from the Merchant Processor 502 to the Card Network 600 corresponding to the specific card brand of the PAN embedded in the Consumer's Credit Card Information 102 (step 3).

The Card Network 600 may then compute the interchange (step 4A), credit Merchant Processor 502 the sale amount less interchange and network fees (step 4B), and debits the Consumer's Card Issuer 112 the sale amount plus interchange fees and provides the Consumer's Credit Card Information (102) (step 4C). Card Issuer 112 may be the specific card issuing institution that issued the Consumer's 100 card, which may be identified by the BIN of the PAN in the Consumer's Credit Card Information 102. The Merchant Processor 502 credits the Merchant 500 sale amount less interchange, network fees, acquiring fees (step 5). The Consumer 100 periodically receives a Credit Card Statement 114 from the Consumer's Card Issuer 112 (step 6). The Consumer 100 pays the Credit Card Statement 114 to the Consumer's Card Issuer 112 (step 7). This process may include several transmissions (i.e., steps 2, 3, and 4C) which may contain some portion of the Consumer's Credit Card Information (102), including the PAN.

Embodiments contemplate a tokenization system that can benefit merchants by increasing the security and reducing regulatory burdens of credit card transactions. Tokenization replaces the consumer's credit card number with a proxy value that is worthless outside of the merchant's payment processing system, enabling the merchant to issue refunds, work chargebacks, and process charges for returning customers without having to store sensitive payment card information. If the merchant suffered a data breach, the cyber thieves would only get meaningless data with no commercial value, rather than their intended target of credit card numbers.

Consumers could limit their shopping to those merchants who used tokenization, but without any public clearinghouse of how merchants are taking any steps to secure the consumer's credit card data, there is currently no meaningful way that consumers can protect their card data in a retail transaction. Therefore, they are subject to the whims of how each merchant they patronize chooses to secure their data. Additionally, while contactless transactions do allow for some of the track data to change with each transaction, this sensitive data is typically transmitted without encryption, leaving the credit card number in the clear.

The European Union has mandated that all new cell phones offered in that region must be NCF-capable in the 2012. While no such governing body exists for the mobile market in the United States, market pressures and opportunities do exist to help make this ability broadly available in mobile consumer devices in the next few years. The recent explosion of mobile phone capabilities coupled with the convergence of mobile computing platforms creates a new realm of payment methodologies previously not possible.

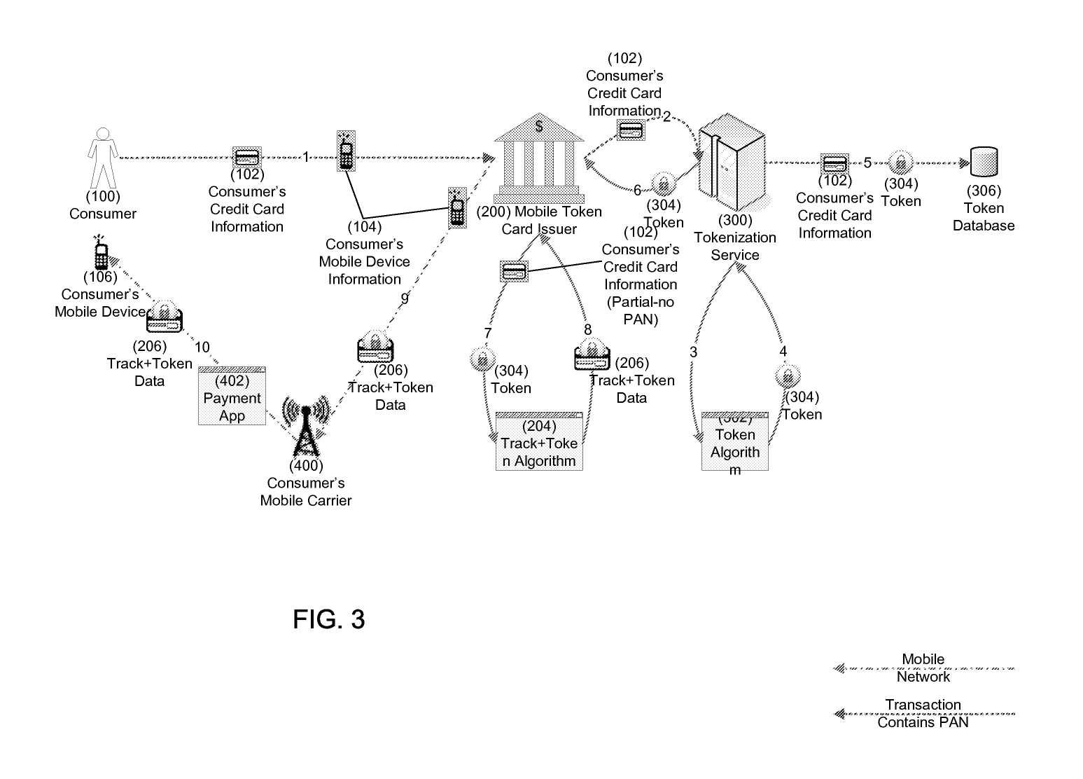

With reference to FIG. 3, a system for registering a credit card so that a tokenization service may be implemented according to an exemplary embodiment is disclosed. In this embodiment of the proposed method, as part of the function of providing consumers with a Token-based transaction, the Consumer 100 registers the Consumer's Credit Card Information 102 and the Consumer's Mobile Device Information 104 with a Mobile Token Card Issuer 200.

It can be appreciated that numerous options can be provided to Consumer 100 when registering the Consumer's Credit Card Information 102 and the Consumer's Mobile Device Information 104 with a Mobile Token Card Issuer 200 (step 1). In one embodiment of the proposed method, the Mobile Token Card Issuer 200 offers a web site for consumers to register their information. In another embodiment, the Consumer 100 also supplies or is supplied with a PIN or other type of password as part of the registration process, which is used when the Consumer attempts to purchase goods or services from a Merchant 500. In yet another example, the Consumer 100 may also supply multiples of the Consumer's Credit Card Information 102 as part of the registration process, which is used when the Consumer attempts to purchase goods or services from a Merchant 500. In another example, Consumer 100 supplies checking and/or savings account information as part of the registration process, which may be used when Consumer 100 attempts to purchase goods or services from a Merchant 500.

The Mobile Token Card Issuer 200 requests a token from the Tokenization Service 300 by supplying the Consumer's Credit Card Information (102) to be tokenized (step 2). Tokenization Service 300 may initiate a Token Algorithm 302 (step 3), which generates a Token 304 (step 4). The Consumer's Credit Card Information 102 and the Token 304 may be securely stored in the Token Database 306 for later retrieval using the Token 304 as a reference lookup (step 5). The Token 304 is transmitted back to Mobile Token Card Issuer 200 (step 6) for instance in response to the request. Token 304 may be transmitted before or after storage in the Token Database 306.

In an exemplary embodiment, the Mobile Token Card Issuer 200 may then provide the token 304, the consumer's credit card brand, and the last four digits of the consumer's credit card number to the Track+Token Algorithm 204 (step 7).

Mobile Token Card Issuer 200 may then generate a unique Track+Token Data 206 through the use of a Track+Token Algorithm 204 (step 8). It can be appreciated that in other embodiments that the entity that generates the Track+Token could be different that Mobile Token Card Issuer 200. In one embodiment of the proposed method, the Track+Token Algorithm 204 creates track data in a standard ISO 7813 Track 1 data for financial institutions format, although numerous formats for the track data are contemplated. Table 1 includes a listing of information that may be included in ISO 7813 Track 1 data for financial institutions, which may be up to 79 characters.

TABLE 1

| | | Typical Value |
|---|---|---|
| Length | Field Name | (if any) |
| 1 | Start Sentinel | % |
| 1 | Format Code | B |
| Up to 19 | Primary Account Number (PAN) | |
| 1 | Field Separator | \hat{ } |
| 2 to 26 | Cardholder Name | |
| 1 | Field Separator | \hat{ } |
| 4 | Expiration Date | |
| 3 | Service Code | |
| Balance of | Discretionary Data (may include | |
| available characters | PVKI, PVV, CVV/CVK/CVC3) | |
| 1 | End Sentinel | ? |
| 1 | Longitudinal Redundancy Check | |
| | (LRC) | |

In an exemplary embodiment, the Track+Token Algorithm 204 creates alternate values for the Primary Account Number PAN field. Rather than using the actual PAN from the Consumer's Credit Card Information 102, new pseudo-PAN element contents may be created. Table 2 includes a listing of information that may be included in the pseudo-PAN element, which, in this embodiment, may be up to 19 numeric characters.

TABLE 2

| Length | Element Name | Sample Value |
|---|---|---|
| 6 | Mobile Token BIN | 411111 |
| Balance of | Discretionary Data | 11111 |
| available characters | | |
| 1 | Check Digit | 1 |
| 4 | Last Four | 1111 |

With reference to Table 2, the Mobile Token BIN may be Mobile Token Card Issuer's 200 BIN that matches the consumer's credit card brand (i.e. Visa, MasterCard, Discover, American Express) used in the Consumer's Credit Card Information 102. The Discretionary Data may be any numeric value or may be reserved for some other processing use. The Check Digit may be the result of a simple checksum formula which may be used on the combination of the other elements of the new pseudo-PAN. The checksum may be used to validate a variety of identification numbers, for example credit card numbers. The Last Four may be the last four digits of the actual PAN from the Consumer's Credit Card Information 102. The Track+Token Algorithm 204 may create values for the Cardholder Name field. Rather than using the Cardholder Name from the Consumer's Credit Card Information 102, the Cardholder Name element contents may be created from the Token 304, and may be up to 26 alphanumeric characters. A sample value for Cardholder Name Field is shown in Table 3.

TABLE 3

| Length | Element Name | Sample Value |
|---|---|---|
| 2 to 26 | Token | 02N8H57ZKFK1JCQ7HGE |

In one embodiment, the Track+Token Algorithm 204 may create values for the Discretionary Data field. Rather than using the Discretionary Data from the Consumer's Credit Card Information 102, the new Discretionary Data element contents may be created from the Token 304, up to the balance of available characters. Token 304 may be the value that relates to the Consumer's Credit Card Information 102, issued by the Mobile Token Card Issuer 200. A sample value for the Discretionary Data field is shown in Table 4.

TABLE 4

| Length | Element Name | Sample Value |
|---|---|---|
| Balance of | Token | 02N8H57ZKFK1JCQ7HGE |
| available characters | | |

The Mobile Token Card Issuer 200 may then transmits the Track+Token Data 206 and the Consumer's Mobile Device Information 104 to the Consumer's Mobile Carrier 400 (step 9). The Consumer's Mobile Carrier 400 may install a Payment Application 402 in the Consumer's Mobile Device 106, which holds the Track+Token Data 206 (step 10).

In an exemplary embodiment of the process depicted in FIG. 3, several transmissions may contain some portion of the Consumer's Credit Card Information (102), including the PAN (i.e., steps 1, 2, and 5).

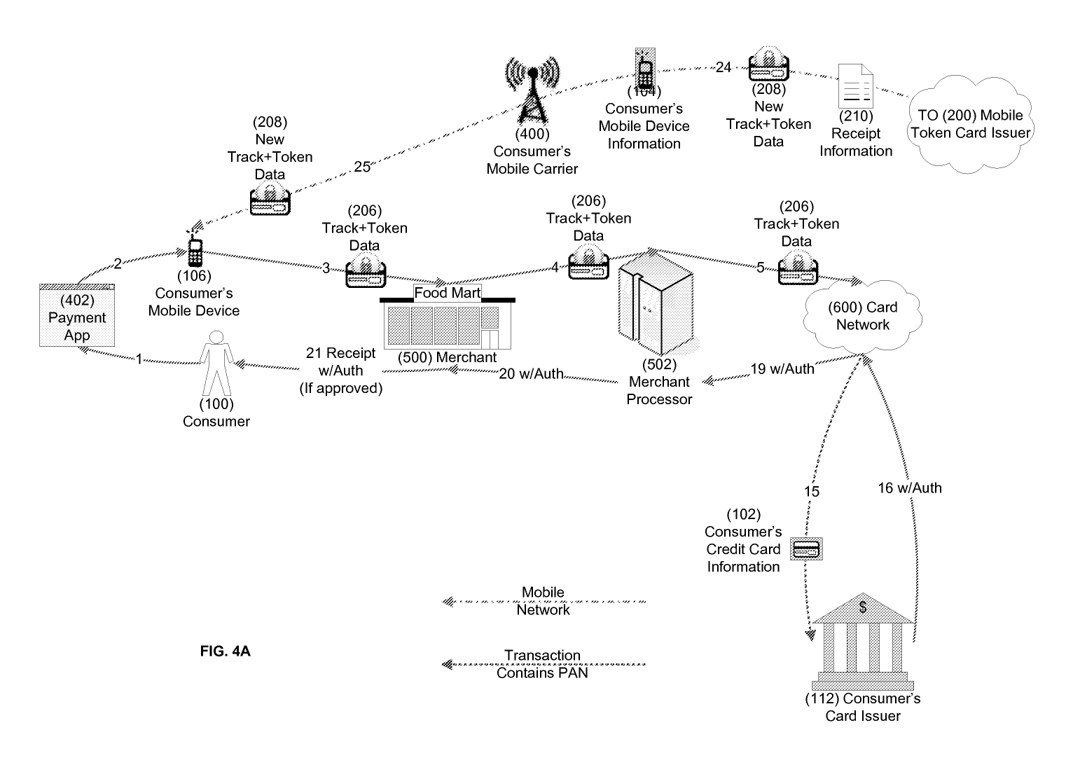

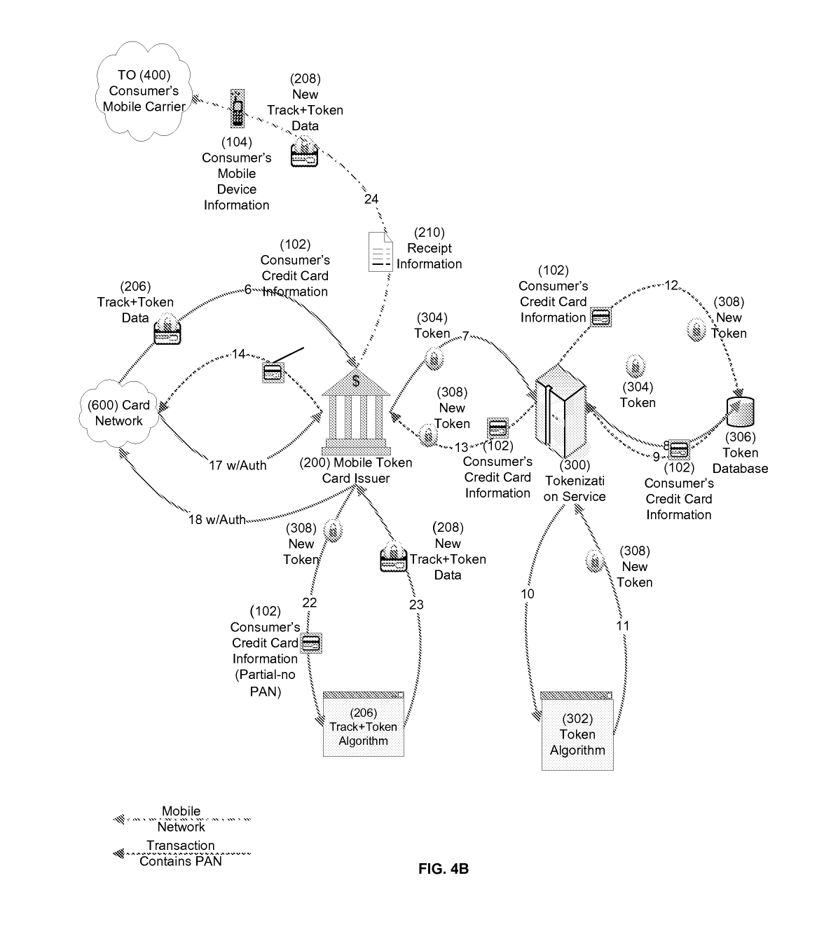

After completion of registration, the Mobile Device 106 may be used to authorize transactions between Consumer 100 and Merchant 500. With reference to FIG. 4A and FIG. 4B, a system for authorizing a credit card transaction using a tokenization service according to an exemplary embodiment is disclosed. To begin a financial transaction, a Consumer 100 purchases products or services from a Merchant 500 using a Payment Application 402 on the Consumer's Mobile Device 106 (steps 1, 2). If added security is desired, the Consumer 100 may also enter a PIN or other type of password that was supplied by the Consumer's Mobile Carrier 400 or to the Consumer 100 as part of the registration process, into the Payment Application 402 on the Consumer's Mobile Device 106 in order to allow access into the Payment Application 402. If multiple payment sources have been registered, then Consumer (100) chooses the specific payment source to use for this authorization attempt from any of the payment sources entered in the registration process.

The Payment Application 402 on the Consumer's Mobile Device 106 may then wirelessly transmit Track+Token Data 206 to Merchant's (500) contactless terminal receiver (step 3). In an exemplary embodiment, the transmission is accomplished using Near Field Communications (NFC). The Track+Token Data 206 is passed from the Merchant 500 to the Merchant Processor 502 (step 4), who routes it to the Card Network 600 corresponding to the card brand in the Track+Token Data (206) (step 5). The Card Network 600 routes the Track+Token Data (206) to the Mobile Token Card Issuer 200, based on the BIN of the pseudo-PAN in the Track+Token Data 206 (step 6).

In one embodiment, the Mobile Token Card Issuer 200 may have an issuing BIN for each card brand a Consumer 100 registers, enabling the pseudo-PAN to mimic the card brand of the actual Consumer's Credit Card Information 102, thus allowing Merchant 500 receipt information to appear correctly. The Mobile Token Card Issuer 200 extracts the Token 304 embedded in the Track+Token Data 206, and forwards the Token 304 to the Tokenization Service 300 (step 7) in order to retrieve the Consumer's Credit Card Information 102 from the Token Database 306. The Consumer's Credit Card Information 102 may be retrieved by the Tokenization Service 300 which queries the Token Database (306) with Token (304) (step 8) and the Token Database (306) which responds to the query with the Consumer's Credit Card Information (step 9).

Embodiments contemplate the use of a new token for each transaction in order to maximize security, so the Tokenization Service 300 may initiate the Token Algorithm 302 (step 10) to generate a New Token 308 for future transactions (step 11). Tokenization Service 300 may then store New Token 308 in relation to the Consumer's Credit Card Information 102 in the Token Database 306 (step 12). The Tokenization Service 300 responds back to the Mobile Token Card Issuer 200's request with Consumer's Credit Card Information 102 and a New Token 308 (step 13). Storage can be done before, during or after the response is provided. Additionally, in some embodiments the Mobile Token Card Issuer 200 and the Tokenization Service 300 may be the same entity.

The Tokenization Service 300 may mark the original Token 304 in the Token Database 306 in such a way that it cannot be used to retrieve the Consumer's Credit Card Information 102 again. For example, Tokenization Service 300 may mark the original Token 304 in such a way that it cannot be used to retrieve the Consumer's Credit Card Information 102 again, after an established period of time. This option may allow Consumer 100 to continue to use the old Token 304 until cell reception was regained for the update, for example if Consumer 100 was in an area with poor network coverage.

The Mobile Token Card Issuer 200 may take the Consumer's Credit Card Information 102 and create a new authorization request based on it, as well as other data sent in the request from the Card Network 600, and forward it to the same Card Network 600 as a new authorization request (step 14). The Mobile Token Card Issuer (200) may modify any characteristics of the transaction. This could include, but not be limited to, the amount or type of transaction. The Card Network 600 routes that information to the specific card issuing institution that issued the Consumer's 100 card, the Consumer's Card Issuer 112 (step 15). The Consumer's Card Issuer 112 approves or declines the authorization request, based on the parameters and thresholds established for the Consumer 100, and responds back to the Card Network 600 with the authorization response (step 16). The Card Network 600 responds back with the authorization response to the Mobile Token Card Issuer 200 (step 17).

The Mobile Token Card Issuer 200 takes that response data and supplies it to the Card Network 600 as a response to the original request that contained the Track+Token Data 206 (step 18). The Card Network 600 forwards that information to the Merchant Processor 502 (step 19), who, in turn, forwards it to the Merchant 500 (step 20). If approved, the Consumer 100 receives the desired goods and/or services from Merchant 500, along with a sales receipt (step 21). In various embodiments, the following feature can be included before, during or after the response is provided from the Mobile Token Card Issuer 200 to the Card Network 600. Mobile Token Card Issuer 200 may generate New Track+Token Data 208 through the use of a Track+Token Algorithm 206 by supplying the Consumer's Credit Card Information 102 and the New Token 308 (steps 22, 23). Mobile Token Card Issuer 200 may send the Consumer's Mobile Device Information 104 and the New Track+Token Data 208 to the Consumer's Mobile Carrier 400 (step 24). Mobile Token Card Issuer 200 may send the Receipt Information 210 from the transaction to the Consumer's Mobile Carrier 400 (step 24). This information can be used to update recent purchase information within the Payment App 402 on the Consumer's Mobile Device 106 with, for example, receipt information 102 (step 25). The Consumer's Mobile Carrier 400 may update the Payment App 402 on the Consumer's Mobile Device 106 with the New Track+Token Data 208 (step 25). In an exemplary embodiment of the process depicted in FIGS. 4A and 4B, several transmissions may contain some portion of the Consumer's Credit Card Information (102), including the PAN (i.e., steps 9 and 12-15).

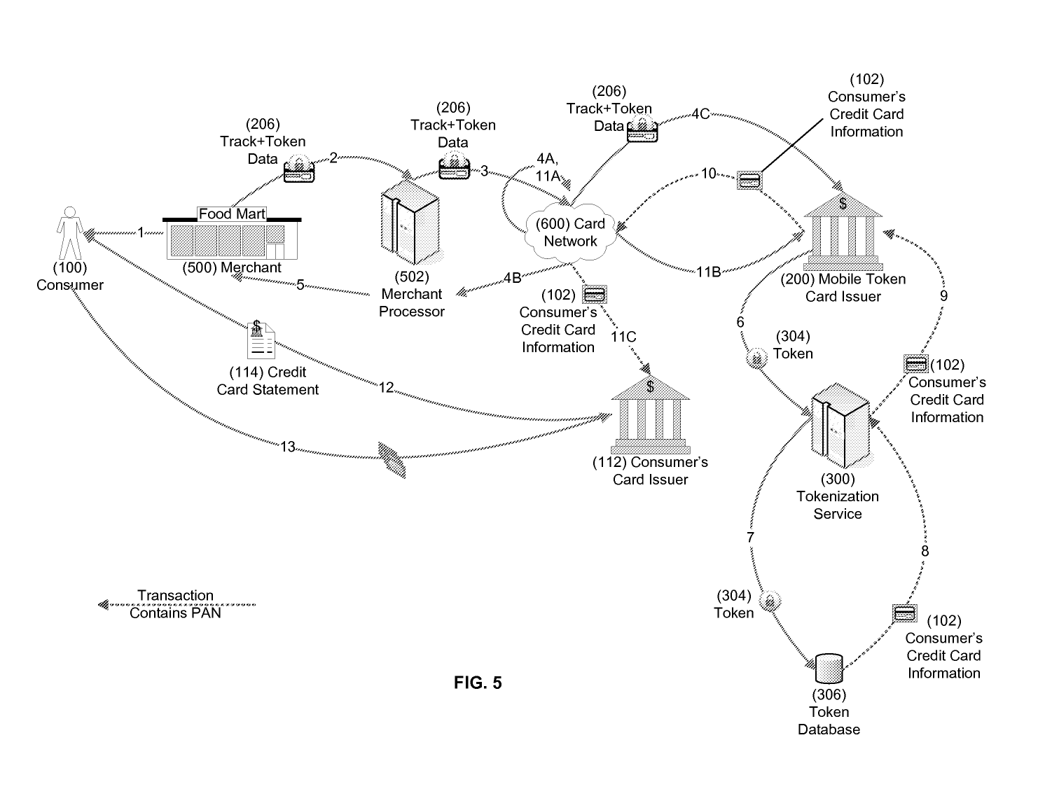

In order to complete the transaction, Merchant 500 may perform the settlement procedure via the Tokenization Service 300. FIG. 5 is a system diagram for credit card settlement according to an embodiment. Consumer 100 has been approved to receive goods and/or services from Merchant 500 (step 1). Typically as part of a daily process, the Merchant 500 transmits the Track+Token Data 206 from the previously authorized transaction to the Merchant's 500 Merchant Processor 502 as a request for settlement funds (step 2). That information may be passed from the Merchant Processor 502 to the Card Network 600 corresponding to the specific card brand of the pseudo-PAN embedded in the Track+Token Data 206 (step 3).

Typically, the Card Network 600 may compute an interchange fee (step 4A), credit the Merchant Processor 502 the sale amount less interchange and network fees (step 4B), and debit the Mobile Token Card Issuer 200 the sale amount plus interchange fees while providing the Track Token Data (step 4C) as it may be the specific card issuing institution that issued the Consumer's 100 card. For example, Merchant Processor 502 may identify Token Card Issuer 200 by the BIN of the pseudo-PAN in the Track+Token Data 206. The Merchant Processor 502 credits the Merchant 500 sale amount less interchange, network fees, and acquiring fees (step 5).

Upon receipt of the Track+Token Data 206, Mobile Token Card Issuer 200 may extract the Token 304 embedded in the pseudo-PAN in the Track+Token Data 206 and forward the Token 304 to the Tokenization Service 300 (step 6) in order to retrieve the Consumer's Credit Card Information 102. The Tokenization Service 300 queries the Token Database 306 with the Token 304 (step 7), and receives the Consumer's Credit Card Information 102 from the Token Database 306 (step 8). The Tokenization Service 300 responds to the Mobile Token Card Issuer 200 with Consumer's Credit Card Information 102 (step 9). To offset the funds charged by the Card Network 600 and move the settlement charge to the Consumer's Card Issuer 112, the Mobile Token Card Issuer 200 may route the settlement request back into to Card Network 600, based on card brand of the actual PAN embedded in Consumer's Credit Card Information 102 (step 10).

Embodiments contemplate that Mobile Token Card Issuer 200 may modify characteristics of the transaction. This may include, but not be limited to, the amount, type of transaction or description that would appear on the Consumer's 100 Credit Card Statement 114. The Card Network 600 may compute the interchange (step 11A), credit the Mobile Token Card Issuer 200 the sale amount less interchange and network fees (step 11B), and debit the Consumer's Card Issuer 112 the sale amount plus interchange fees while forwarding Consumer's Credit Card Information (102), the specific card issuing institution that issued the Consumer's 100 card, which may be identified by the BIN of the PAN in the Consumer's Credit Card Information 102. Consumer 100 periodically receives a Credit Card Statement 114 from the Consumer's Card Issuer 112 (step 12). The Consumer 100 pays the Credit Card Statement 114 to the Consumer's Card Issuer 112 (step 13).

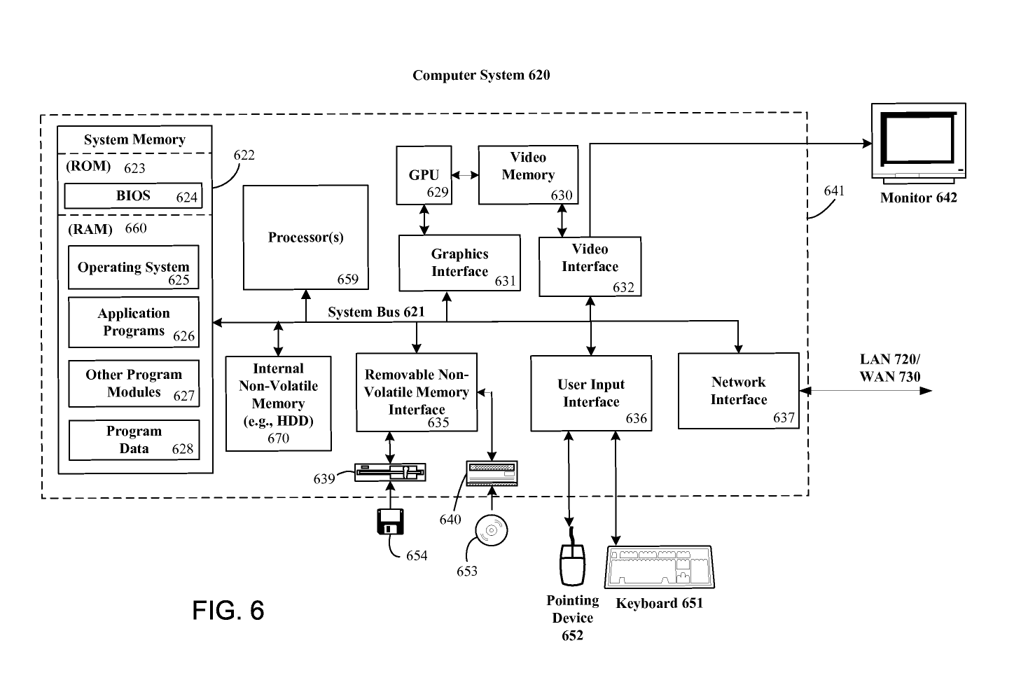

FIG. 6 is a block diagram of an example computer system 620 on which the embodiments described herein and/or various components thereof may be implemented. For example, the functions performed by the entities described in the various embodiments above may be performed by one or more such example computer systems. For example, Consumer's Card Issuer 112, Mobile Token Card Issuer 200, Track+Token Algorithm 204, Tokenization Service 300, Token Algorithm 302, Token Database 306, Payment App 402, Merchant Processor 502, Credit Card Network 600, may all be implemented, in whole or in part, in software (i.e., computer executable instructions or program code) executing on one or more such computer systems 620. It is understood, however, that the computer system 620 is just one example of a suitable computing environment and is not intended to suggest any limitation as to the scope of use or functionality of the presently disclosed subject matter. Neither should the computer system 620 be interpreted as having any dependency or requirement relating to any one or combination of components illustrated in FIG. 6. Since the state of the art has evolved to a point where there is little difference between hardware, software, or a combination of hardware/software, the selection of hardware versus software to effectuate specific functions is a design choice left to an implementer. More specifically, a software process may be transformed into an equivalent hardware structure, and a hardware structure may itself be transformed into an equivalent software process. Thus, the selection of a hardware implementation versus a software implementation is one of design choice and left to the implementer.

In FIG. 6, the computer system 620 comprises a computer 641, which may include a variety of computer readable media. Computer readable media may be available media that may be accessed by computer 641 and may include volatile and/or nonvolatile media, removable and/or non-removable media. The system memory 622 may include computer storage media in the form of volatile and/or nonvolatile memory such as read only memory (ROM) 623 and random access memory (RAM) 660. A basic input/output system 624 (BIOS), containing the basic routines that help to transfer information between elements within computer 641, such as during start-up, may be stored in ROM 623. RAM 660 may contain data and/or program modules that are immediately accessible to and/or presently being operated on by processing unit 659. By way of example, and not limitation, FIG. 6 illustrates operating system 625, application programs 626, other program modules 627, and program data 628. As a further example, financial transaction information and/or Interchange fee information may, in one embodiment, be stored in the system memory 622, as well as in any of a variety of non-volatile memory media discussed herein.

The computer 641 may also include other removable/non-removable, volatile/nonvolatile computer storage media. By way of example, the computer 641 may include a hard disk drive 670 that reads from or writes to non-removable, nonvolatile magnetic media, a magnetic disk drive 639 that reads from or writes to a removable, nonvolatile magnetic disk 654, and an optical disk drive 640 that reads from or writes to a removable, nonvolatile optical disk 653 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. Magnetic disk drive 639 and optical disk drive 640 may be connected to the system bus 621 by a removable memory interface, such as interface 635. The drives and their associated computer storage media discussed herein, and illustrated in FIG. 6, may provide storage of computer readable instructions, data structures, program modules and other data for the computer 641.

A user may enter commands and information into the computer 641 through input devices such as a keyboard 651 and/or pointing device 652, commonly referred to as a mouse, trackball, or touch pad. Other input devices (not shown) may include a microphone, joystick, game pad, satellite dish, scanner, or the like. These and other input devices may be connected to the processing unit 659 through a user input interface 636 that is coupled to the system bus, but may be connected by other interface and/or bus structures, such as a parallel port, game port, or a universal serial bus (USB) for example. The computer may connect to a local area network or wide area network, such as LAN 720 and/or WAN 730, through a network interface or adapter 637.

As is apparent from the embodiments described herein, all or portions of the various systems, methods, and aspects of the present invention may be embodied in hardware, software, or a combination of both. When embodied in software, the methods and apparatus of the present invention, or certain aspects or portions thereof, may be embodied in the form of program code (i.e., computer executable instructions). This program code may be stored on a computer-readable storage medium, such as a magnetic, electrical, or optical storage medium, including without limitation a floppy diskette, CD-ROM, CD-RW, DVD-ROM, DVD-RAM, magnetic tape, flash memory, hard disk drive, or any other machine-readable storage medium, wherein, when the program code is loaded into and executed by a machine, such as a computer or server, the machine becomes an apparatus for practicing the invention. A computer on which the program code executes may include a processor, a storage medium readable by the processor (including volatile and/or non-volatile memory and/or storage elements), at least one input device, and/or at least one output device. The program code may be implemented in a high level procedural or object oriented programming language. Alternatively, the program code may be implemented in an assembly or machine language. In any case, the language may be a compiled or interpreted language. When implemented on a general-purpose processor, the program code may combine with the processor to provide a unique apparatus that operates analogously to specific logic circuits. As used herein, the terms “computer-readable medium” and “computer-readable storage medium” do not include a signal.

As the foregoing illustrates, the present invention is directed to systems, methods, and apparatus for providing estimated Interchange fees associated with a financial transaction. Changes may be made to the embodiments described above without departing from the broad inventive concepts thereof. Accordingly, the present invention is not limited to the particular embodiments disclosed, but is intended to cover all modifications that are within the spirit and scope of the invention as defined by the appended claims.

What is claimed:

1. A method for facilitating a credit card transaction wirelessly via a mobile device, the method comprising:
receiving registration information for a credit card and a mobile device, the registration information for the credit card including a primary account number (PAN) of the credit card;
associating the registration information for the credit card with a unique token;
generating a pseudo-PAN based on the PAN, the pseudo-PAN being different than the PAN; and
providing the unique token and the pseudo-PAN to the mobile device for use in one or more credit card transactions.

2. The method of claim 1, wherein the pseudo-PAN contains a Bank Identification Number (BIN) identical to a Bank Identification Number (BIN) of the PAN; wherein the pseudo-PAN contains four digits identical to the last four digits of the PAN; and wherein the pseudo-PAN contains discretionary data that differs from the PAN.

3. The method of claim 2, wherein the discretionary data contains the unique token.

4. The method of claim 1, wherein the unique token is a single use token.

5. The method of claim 1, wherein the registration information for the credit card and the mobile device is received through a web site.

6. The method of claim 1 further comprising:
establishing a password, wherein the password is associated with the unique token.

7. The method of claim 1, further comprising:
receiving registration information for a second credit card;
associating the registration information for the second credit card with a second unique token;
generating a second unique token and a second pseudo-PAN, the second pseudo-PAN being different than the PAN and the pseudo-PAN; and
providing the second unique token and the second pseudo-PAN to the mobile device.

8. The method of claim 1, further comprising:
storing a copy of the token in a database.

9. The method of claim 1, wherein the unique token expires after a predetermined period of time.

10. A method for facilitating a credit card transaction via a mobile device, the method comprising:
receiving a unique token and a pseudo-PAN;
identifying an actual PAN based on the unique token and the pseudo-PAN, the pseudo-PAN being associated with the actual PAN, the pseudo PAN being different than the actual PAN; and
sending the actual PAN to an entity that uses the actual PAN to determine if the credit card transaction is approved.

11. The method of claim 10, wherein the credit card transaction is approved in connection with a settlement request.

12. The method of claim 10, therein the credit card transaction is approved in connection with an authorization request.

13. The method of claim 12, further comprising:
generating a second unique token and a second pseudo-PAN;
sending the second unique token and the second pseudo-PAN to the mobile device; and
preventing, after the second unique token and the second pseudo-PAN has been sent, the unique token from being used to identify an actual PAN.

14. The method of claim 12, further comprising:
preventing the unique token from being used to identify an actual PAN after a predetermined period of time.

15. The method of claim 10, wherein the unique token and pseudo-PAN are received using Near Field Communications.

16. The method of claim 10, wherein identifying the actual PAN comprises:
retrieving the actual credit card number from a database using the unique token, the database linking the actual credit card number to the unique token.

17. The method of claim 16 further comprising:
extracting a BIN from the pseudo-PAN, wherein the BIN from the pseudo-PAN is identical to a BIN of the PAN; and
retrieving the actual credit card number from the database using the extracted BIN, the extracted BIN being used to identify a credit card network associated with the BIN of the pseudo-PAN.

18. The method of claim 16 further comprising:
extracting the last four digits of the PAN from the pseudo-PAN, wherein the pseudo-PAN contains four digits that are identical to the last four digits of the PAN; and
providing the last four digits of the PAN to a merchant for display on a receipt.

19. The method of claim 10, wherein the unique token and the pseudo primary account number (PAN) is received from a mobile device.

20. The method of claim 19, wherein the unique token and the pseudo primary account number (PAN) is received from an application running on the mobile device.
